(19) United States
(12) Patent Application Publication
(10) Pub. No.: US 2017/0068841 A1
(43) Pub. Date: Mar. 9, 2017

(54) DETECTING DEVICE, AND DETECTING METHOD

(71) Applicant: KABUSHIKI KAISHA TOSHIBA, Tokyo (JP)

(72) Inventors: Tomokazu Kawahara, Yokohama Kanagawa (JP); Osamu Yamaguchi, Yokohama Kanagawa (JP)

(21) Appl. No.: 15/258,198

(22) Filed: Sep. 7, 2016

(30) Foreign Application Priority Data
Sep. 8, 2015 (JP) 2015-176654

(51) Int. Cl. G06K 9/00; H04N 21/442

(52) U.S. Cl. CPC G06K 9/00228; G06K 9/00302; G06K 9/00375; G06K 9/00771; H04N 21/44218

(57) ABSTRACT

According to an embodiment, a detecting device includes processing circuitry. The processing circuitry obtains observation data formed as a result of observing a person. The processing circuitry identifies an attribute of the person based at least in part on the observation data. The processing circuitry detects, based at least in part on the observation data, presence or absence of a predetermined reaction of the person by implementing a detecting method corresponding to the attribute.

### CROSS-REFERENCE TO RELATED APPLICATIONS

This application is based upon and claims the benefit of priority from Japanese Patent Application No. 2015-176654, filed on Sep. 8, 2015; the entire contents of which are incorporated herein by reference.

### FIELD

Embodiments described herein relate generally to a detecting device, and a detecting method.

### BACKGROUND

A technology has been proposed in which a predetermined reaction, such as a smile, of persons watching a moving image is detected and counted.

### BRIEF DESCRIPTION OF THE DRAWINGS

FIG. 1 is a configuration diagram illustrating an example of a detecting device according to a first embodiment;

FIG. 2 is an explanatory diagram of an exemplary face detecting method according to the first embodiment;

FIG. 3 is a diagram illustrating an example of information stored in a first memory unit according to the first embodiment;

FIG. 4 is a diagram illustrating an example of information stored in the first memory unit according to the first embodiment;

FIG. 5 is a flowchart for explaining an exemplary flow of operations performed according to the first embodiment;

FIG. 6 is a configuration diagram illustrating an example of a detecting device according to a second embodiment;

FIG. 7 is a diagram illustrating an example of statistical information according to the second embodiment;

FIG. 8 is a diagram illustrating an example of statistical information according to the second embodiment;

FIG. 9 is a diagram illustrating an example of statistical information according to the second embodiment;

FIG. 10 is a diagram illustrating an example of statistical information according to the second embodiment;

FIG. 11 is a flowchart for explaining an exemplary flow of operations performed according to the second embodiment;

FIG. 12 is a diagram illustrating an exemplary system in which the detecting device according to the embodiments is implemented;

FIG. 13 is a diagram illustrating an exemplary system in which the detecting device according to the embodiments is implemented;

FIG. 14 is a diagram illustrating an example of statistical information in application examples;

FIG. 15 is a diagram illustrating an example of statistical information in application examples; and

FIG. 16 is a diagram illustrating an exemplary hardware configuration of the detecting device according to the embodiments.

### DETAILED DESCRIPTION

According to an embodiment, a detecting device includes processing circuitry. The processing circuitry obtains observation data formed as a result of observing a person. The processing circuitry identifies an attribute of the person based at least in part on the observation data. The processing circuitry detects, based at least in part on the observation data, presence or absence of a predetermined reaction of the person by implementing a detecting method corresponding to the attribute.

Embodiments of the invention are described below in detail with reference to the accompanying drawings.

### First Embodiment

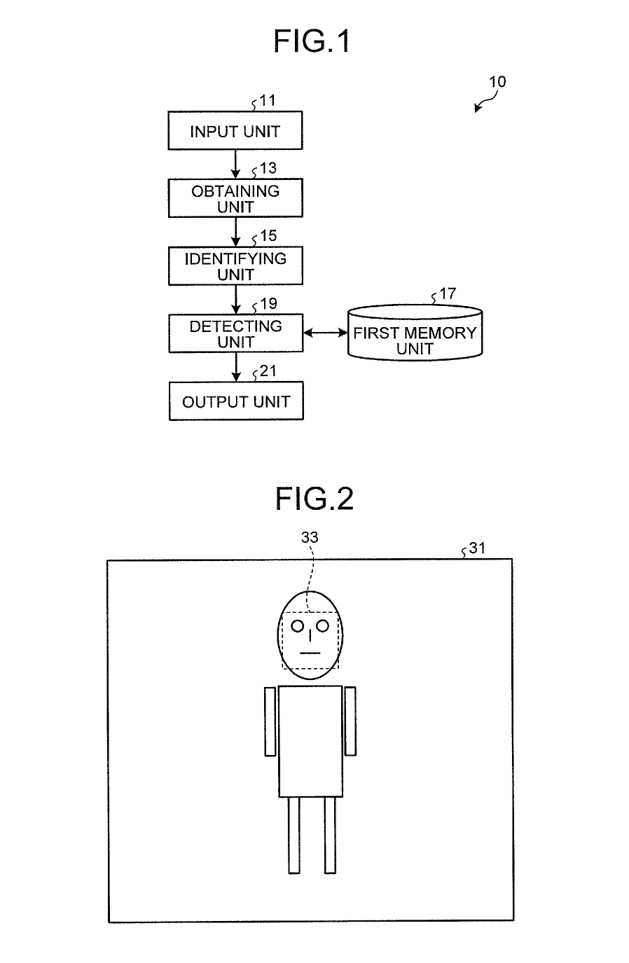

FIG. 1 is a configuration diagram illustrating an example of a detecting device 10 according to a first embodiment. As illustrated in FIG. 1, a detecting device 10 includes an input unit 11, an obtaining unit 13, an identifying unit 15, a first memory unit 17, a detecting unit 19, and an output unit 21.

The input unit 11 can be implemented using an imaging device such as a video camera capable of taking moving images or a camera capable of serially taking still images. The obtaining unit 13, the identifying unit 15, the detecting unit 19, and the output unit 21 can be implemented by executing computer programs in a processor such as a central processing unit (CPU), that is, can be implemented using software; or can be implemented using hardware such as an integrated circuit (IC); or can be implemented using a combination of software and hardware. The first memory unit 17 can be implemented using a memory device such as a hard disk drive (HDD), a solid state drive (SSD), a memory card, an optical disk, a read only memory (ROM), or a random access memory (RAM) in which information can be stored in a magnetic, optical, or electrical manner.

The input unit 11 receives input of observation data formed as a result of observing the target person for detection of a predetermined reaction. The observation data contains a taken image in which the target person for detection of a predetermined reaction is captured. Moreover, the observation data can contain at least any one of the sounds produced by the target person for detection of a predetermined reaction and personal information of that person. Examples of the personal information include gender, age, nationality, and name. However, those are not the only possible examples.

When the observation data contains sounds, the input unit 11 can be implemented using a sound input device, such as a microphone, in addition to using the imaging device; or the input unit 11 can be implemented using an imaging device that is also capable of receiving sound input (i.e., an imaging device including a sound input device). When the observation data contains personal information and when the personal information is stored in a memory medium such as a smartphone, a tablet terminal, a cellular phone, or an IC card possessed by the target person for detection of a predetermined reaction; the input unit 11 can be implemented using a communication device, such as a near field communication device, in addition to using the imaging device, or the personal information can be obtained from the memory medium using near field communication. Alternatively, when the observation data contains personal information and when the personal information is stored in a memory device included in the detecting device 10, the input unit 11 can be implemented using the memory device in addition to using an imaging device.

The predetermined reaction can be any type of reaction of a person. Examples of the predetermined reaction include laughing, feeling astonished, feeling bothered, frowning, being impressed, gazing, reading characters, and going away. However, those are not the only possible examples.

The obtaining unit 13 obtains observation data that is formed as a result of observing the target person for detection of a predetermined reaction. More particularly, the obtaining unit 13 obtains the observation data of the target person for detection of a predetermined reaction from the input unit 11.

The identifying unit 15 identifies, based on the observation data obtained by the obtaining unit 13, the attribute of the target person for detection of a predetermined reaction. Herein, the attribute includes at least any one of gender, age, generation (including the generation-dependent category such as child, adult, or elderly), race, and name.

For example, when the attribute of the target person for detection of a predetermined reaction is to be identified from a taken image included in the observation data, the identifying unit 15 detects a face rectangle 33 from a taken image 31 as illustrated in FIG. 2 and identifies the attribute based on the face image present in the detected face rectangle 33.

Herein, the detection of a face rectangle can be done by implementing the method disclosed in, for example, Takeshi Mita, Toshimitsu Kaneko, Bjorn Stenger, Osamu Hori: “Discriminative Feature Co-Occurrence Selection for Object Detection”. IEEE Transaction Pattern Analysis and Machine Intelligence Volume 30, Number 7, July 2008, pp. 1257-1269.

Moreover, the identification of attributes based on a face image can be done by implementing the method disclosed in, for example, Tomoki Watanabe, Satoshi Ito, Kentaro Yokoi: “Co-occurrence Histogram of Oriented Gradients for Human Detection”, IPSJ Transaction on Computer Vision and Applications Volume 2 March 2010, pp. 39-47 (hereinafter, sometimes referred to as “reference literature”). The reference literature discloses identifying, using a 2-class classifier, whether the input pattern represents a “person” or represents a “non-person”. Hence, in the case of identification of three or more types, two or more 2-class classifiers can be used.

For example, when the gender serves as the attribute, it is sufficient to be able to identify whether the person is a male or a female. Hence, using a 2-class classifier that identifies whether the person is a “male” or a “female”, it becomes possible to identify whether the person having the face image in the face rectangle 33 is a “male” or a “female”.

Alternatively, for example, when the generation serves as the attribute and when three categories, namely, younger than 20 years of age, 20 years of age and older but 60 years of age and younger, and 60 years of age and older are to be identified; using a 2-class classifier that identifies whether a person is “younger than 20 years of age” or “20 years of age and older” and using a 2-class classifier that enables whether a person is “younger than 60 years of age” or “60 years of age and older”, it becomes possible to identify whether the person having the face image in the face rectangle 33 is “younger than 20 years of age”, or “20 years of age and older but 60 years of age and younger”, or “60 years of age and older”.

Still alternatively, for example, when the name serves as the attribute, as attribute identification based on a face image, it is possible to implement the personal identification method using face recognition as disclosed in, for example, Japanese Patent Application Laid-open No. 2006-221479.

Meanwhile, for example, if personal information is included in the observation data, then the identifying unit 15 can identify the attribute using the personal information.

The first memory unit 17 stores therein, in association with to each attribute, a detecting method appropriate for the attribute. That is because, even if the predetermined reaction is identical, the action for expressing the predetermined reaction is often different depending on the attributes of each person, and thus the predetermined reaction cannot be correctly detected using only a single detecting method. Meanwhile, in the first embodiment, an action not only includes movements of body parts such as the face and the hands but also includes changes in the expressions.

For example, when the predetermined reaction is laughing, a child would express the reaction by laughing loudly with his or her mouth wide open, while an adult person would express the reaction by laughing with a change in the expression to the extent of moving the lips. Moreover, a western person would express the reaction by laughing with eyes open and clapping hands, which tends to be a bigger laughing action as compared to an Asian person.

In this way, even if the predetermined reaction is identical, the action for expressing the predetermined reaction is different depending on the attributes of each person. Hence, in the first embodiment, for each attribute, the attribute-specific action for expressing the predetermined reaction is detected, and a detecting method for detecting the predetermined reaction is provided. The action for expressing the predetermined reaction includes at least any one of a change in the expression suggesting the predetermined reaction, a movement of face, and a movement of hands. However, that is not the only possible case.

For example, if the algorithm or the detector meant for detecting the presence or absence of the predetermined reaction is different for each attribute, then the algorithm or the detector itself represents the detecting method corresponding to the attribute.

Moreover, for example, if the algorithm or the detector is common regardless of the attribute but if dictionary data used in the algorithm or in the detector is different for each algorithm, then the dictionary data for each attribute represents the detecting method corresponding to the attribute. Examples of the dictionary data include training data obtained by performing statistical processing (learning) of a large volume of sample data.

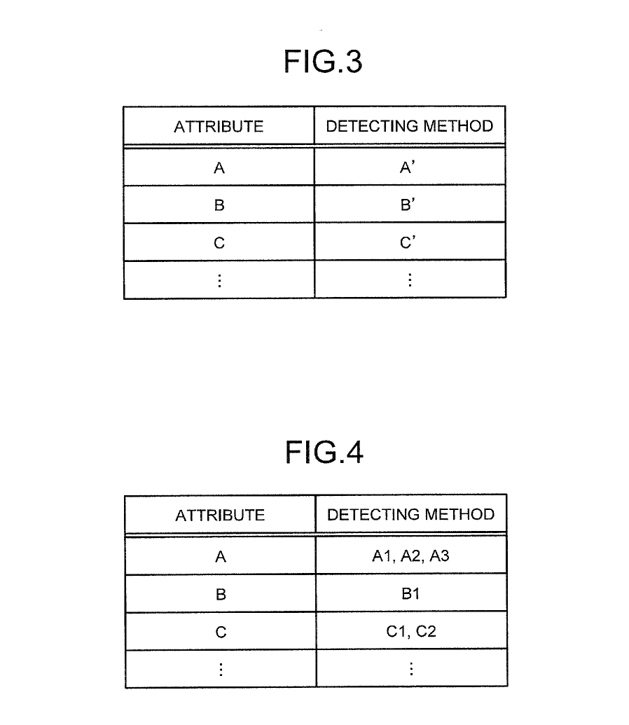

Meanwhile, as illustrated in FIG. 3, in the first memory unit 17, for each attribute, a single detecting method appropriate for the attribute can be stored in association with the attribute. Alternatively, as illustrated in FIG. 4, in the first memory unit 17, for each attribute, one or more detecting methods appropriate for the attribute can be stored in association with the attribute.

As an example of associating one or more detecting methods with the attributes, it is possible to think of a case in which the presence or absence of the predetermined reaction cannot be detected by implementing a single detecting method. For example, when the predetermined reaction is laughing, loud laughing as well as smiling is treated as laughing. However, in the case in which a single detecting method can correctly detect loud laughing but cannot correctly detect smiling, a detecting method for loud laughing and a detecting method for smiling are associated to the attributes.

However, a detecting method for loud laughing and a detecting method for smiling need not be associated with all attributes. That is, regarding the attributes for which loud laughing as well as smiling cannot be correctly detected by implementing only a single detecting method, a detecting method for loud laughing and a detecting method for smiling can be associated. On the other hand, regarding the attributes for which loud laughing as well as smiling can be correctly detected by implementing only a single detecting method, only a single detecting method for laughing can be associated.

As another example of associating one or more detecting methods to the attributes, it is possible to think of a case in which the presence or absence of the predetermined reaction can be detected by implementing a plurality of detecting methods. For example, it is possible to think a case in which, when the predetermined reaction is laughing, a plurality of detecting methods for laughing is available.

The detecting unit 19 detects, from the observation data obtained by the obtaining unit 13, the presence or absence of the predetermined reaction of the target person for detection by implementing the detecting method corresponding to the attribute that is identified by the identifying unit 15. More particularly, the detecting unit 19 obtains, from the first memory unit 17, one or more detecting methods associated with the attribute that is identified by the identifying unit 15; and, from the observation data (more specifically, a taken image) obtained by the obtaining unit 13, detects the presence or absence of the predetermined reaction of the target person for detection by implementing the obtained one or more detecting methods.

In the first embodiment, it is assumed that the detecting methods stored in the first memory unit 17 represent dictionary data, and that the detecting unit 19 detects the presence or absence of the predetermined reaction of the target person for detection by using the dictionary data, which is obtained from the first memory unit 17, in a common detector. As the detecting method of the detector used by the detecting unit 19, it is possible to implement the detecting method using a 2-class classifier as explained above in the reference literature.

In this case, the detection result obtained by the detecting unit 19 is expressed as a value between 0 and 1. Herein, closer the value of the detection result to 1, the higher becomes the degree of certainty that the predetermined reaction of the target person for detection is detected. On the other hand, closer the value of the detection result to 0, the lower becomes the degree of certainty that the predetermined reaction of the target person for detection is detected. Hence, for example, if the detection result exceeds a threshold value, it implies that the detecting unit 19 detects the predetermined reaction of the target person for detection. However, if the detection result is smaller than the threshold value, it implies that the detecting unit 19 does not detect the predetermined reaction of the target person for detection.

When the observation data obtained by the obtaining unit 13 contains sounds, the detecting unit 19 can at least either perform detection of the presence or absence of the predetermined reaction of the target person for detection using the taken image or perform detection of the presence or absence of the predetermined reaction of the target person for detection using the sounds.

For example, when the predetermined reaction is laughing and when the attribute is a child (for example, younger than 20 years of age); the detection of the presence or absence of the predetermined reaction of the target person for detection using the taken image includes detecting laughing by detecting the action of opening the mouth wide, while the detection of the presence or absence of the predetermined reaction of the target person for detection using the sounds includes detecting laughing by detecting the action of yelling out.

For example, the detecting unit 19 can integrate the detection result of detecting the presence or absence of the predetermined reaction of the target person for detection using the taken image and the detection result of detecting the presence or absence of the predetermined reaction of the target person for detection using the sounds; perform threshold processing; and then determine the presence or absence of the predetermined reaction of the target person for detection.

Alternatively, for example, the detecting unit 19 can perform threshold processing with respect to the detection result of detecting the presence or absence of the predetermined reaction of the target person for detection using the taken image; perform threshold processing with respect to the detection result of detecting the presence or absence of the predetermined reaction of the target person for detection using the sounds; and, if both detection results exceed the threshold value or either one of the detection results exceeds the threshold value, can consider that the predetermined reaction of the target person for detection is detected.

Meanwhile, even in the case of detecting the presence or absence of the predetermined reaction of the target person for detection by implementing a plurality of detecting methods, the detection of the presence or absence of the predetermined reaction of the target person for detection can be finalized in an identical manner to the case in which the observation data contains sounds.

The output unit 21 outputs the detection result obtained by the detecting unit 19. For example, the output unit 21 outputs, on a display (not illustrated), whether or not the predetermined reaction of the target person for detection is detected. Meanwhile, if the detecting device 10 detects the predetermined reaction (for example, laughing) of a person who is viewing a moving image or a still image being displayed on a display (not illustrated), then the information indicating whether or not the predetermined reaction is detected can be displayed in a superimposed manner on the moving image or the still image.

Meanwhile, in addition to outputting the presence or absence of detection of the predetermined reaction, the detecting unit 19 can also output at least any one of the attribute identified by the identifying unit 15, the date and time, the installation location of the detecting device 10, and the control number of the detecting device 10.

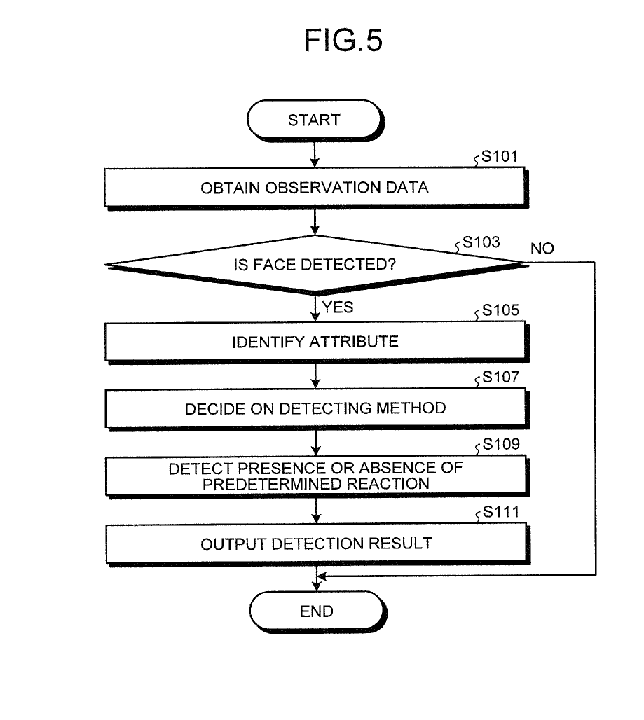

FIG. 5 is a flowchart for explaining an exemplary flow of operations performed according to the first embodiment.

Firstly, the obtaining unit 13 obtains, from the input unit 11, the observation data of the target person for detection of the predetermined reaction (Step S101).

Then, the identifying unit 15 performs face detection with respect to the taken image included in the observation data that is obtained by the obtaining unit 13 (Step S103). If no face is detected during face detection (No at Step S103), then the operations end.

When a face is detected during face detection, that is, when the face of the target person for detection of the predetermined reaction is detected (Yes at Step S103), the identifying unit 15 identifies, based on the detected face (face image), the attribute of the target person for detection of the predetermined reaction (Step S105).

Subsequently, the detecting unit 19 obtains, from the first memory unit 17, one or more detecting methods associated with the attribute that is identified by the identifying unit 15, and decides the one or more detecting methods as the detecting methods for detecting the predetermined reaction (Step S107).

Then, by implementing the one or more detecting methods that are decided, the detecting unit 19 detects the presence or absence of the predetermined reaction of the target person for detection (Step S109).

Subsequently, the output unit 21 outputs the detection result obtained by the detecting unit 19 (Step S111).

In this way, according to the first embodiment, the presence or absence of the predetermined reaction is detected by implementing the detecting method corresponding to the attribute of the target person for detection of the predetermined reaction. That enables achieving enhancement in the detection accuracy of the predetermined reaction of the person. Particularly, according to the first embodiment, even in the case in which the action for expressing the predetermined reaction is different depending on the attribute of each person, the presence or absence of the predetermined reaction can be correctly detected regardless of the person.

### Second Embodiment

In a second embodiment, the explanation is given about an example of counting the detection results. The following explanation is mainly given about the differences with the first embodiment. Moreover, the constituent elements having identical functions to the first embodiment are referred to by the same names and reference numerals as the first embodiment, and the explanation of such constituent elements is not repeated.

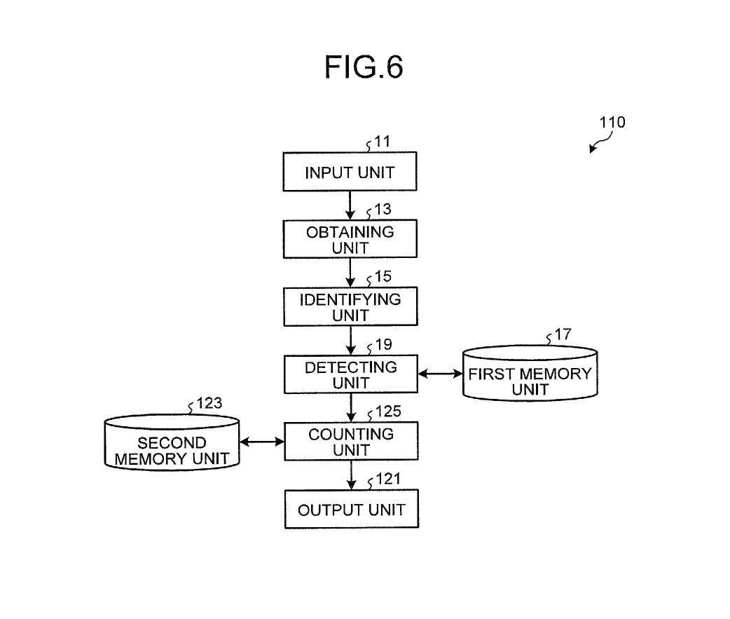

FIG. 6 is a diagram illustrating an exemplary configuration of a detecting device 110 according to the second embodiment. As illustrated in FIG. 6, in the detecting device 110; a second memory unit 123, a counting unit 125, and an output unit 121 are different than the first embodiment.

The second memory unit 123 can be implemented using a memory device such as an HDD, an SSD, a memory card, an optical disk, a ROM, or a RAM in which information can be stored in a magnetic, optical, or electrical manner. The counting unit 125 can be implemented by executing a computer program in a processor such as a CPU, that is, can be implemented using software; or can be implemented using hardware such as an integrated circuit (IC); or can be implemented using a combination of software and hardware.

The second memory unit 123 stores therein statistical information obtained by counting the detection results of the presence or absence of the predetermined reaction of a plurality of persons.

The counting unit 125 counts the detection results of the presence or absence of the predetermined reaction of a plurality of persons and generates statistical information. More particularly, the counting unit 125 obtains the statistical information till the previous time from the second memory unit 123 and reflects, in the obtained statistical information, the detection result of the presence or absence of the predetermined reaction of a person as newly obtained by the detecting unit 19.

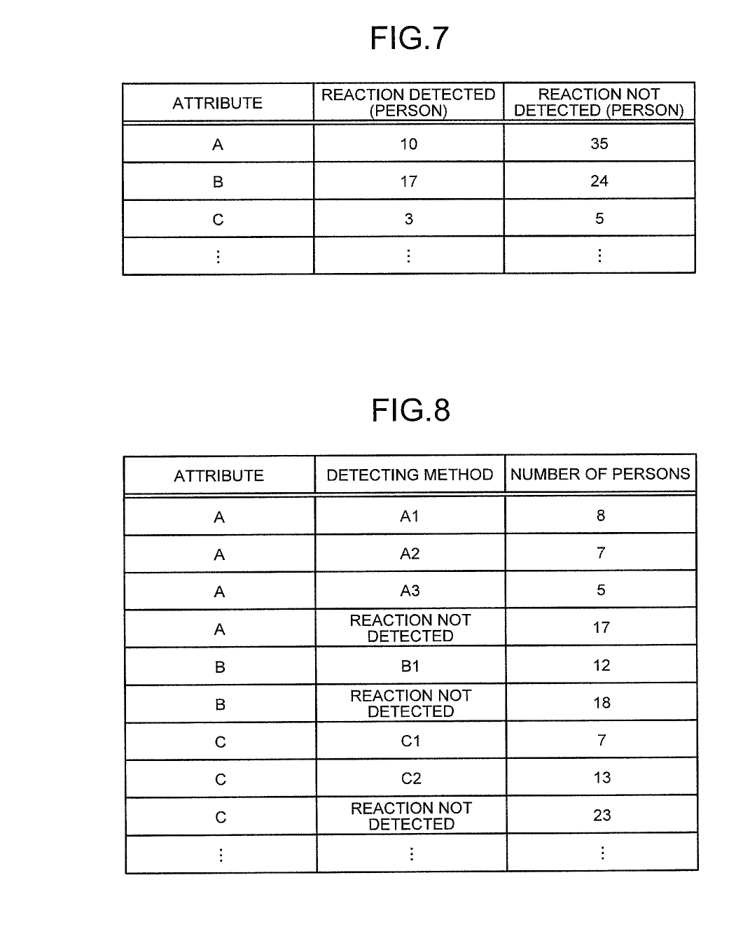

For example, as illustrated in FIG. 7, the statistical information contains, for each attribute identified by the identifying unit 15, the count of the presence and the absence of detection of the predetermined reaction of persons.

Moreover, for example, as illustrated in FIG. 8, the statistical information contains, for each attribute identified by the identifying unit 15 and for each detecting method associated with the attribute (see FIG. 4), the count of the persons for which the predetermined reaction is detected. In the example illustrated in FIG. 8, for each attribute identified by the identifying unit 15, a row indicating the counting result of the number of persons for which the predetermined reaction is not detected is also specified. However, the row may be omitted.

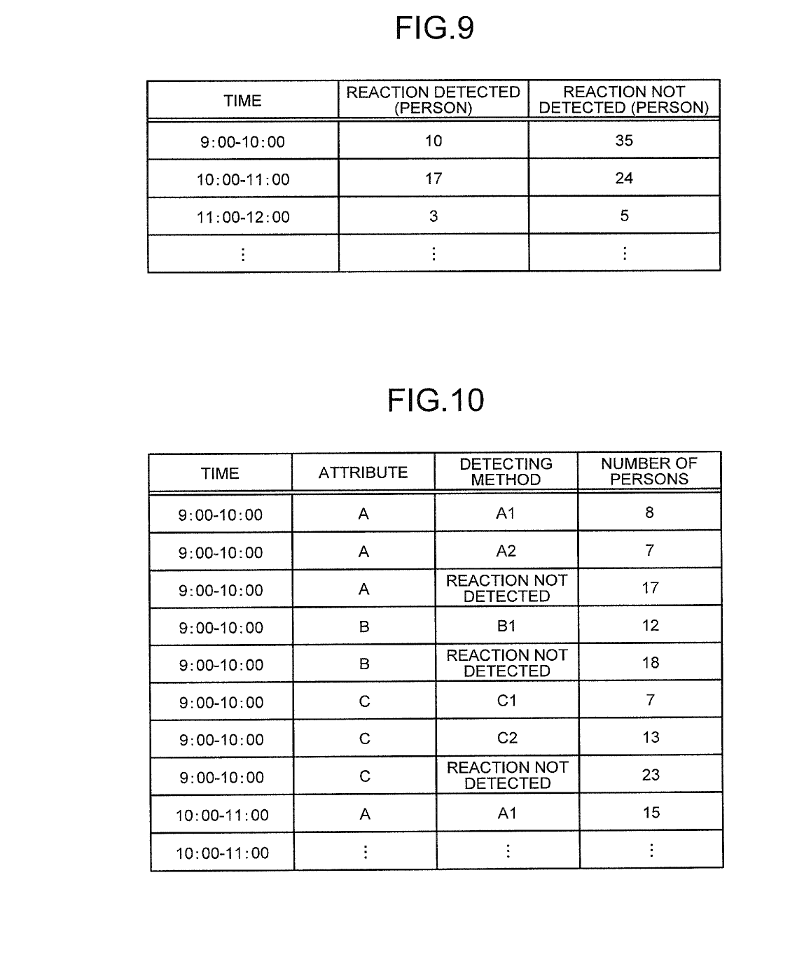

For example, as illustrated in FIG. 9, the statistical information contains, for each time slot, the count of the presence and the absence of detection of the predetermined reaction of persons. In this case, the detecting unit 19 may include the date and time of detection in the detection results.

Furthermore, for example, as illustrated in FIG. 10, the statistical information contains, for each time slot, for each attribute identified by the identifying unit 15, and for each detecting method associated with the attribute (see FIG. 4), the count of the persons for which the predetermined reaction is detected. In the example illustrated in FIG. 10, for each time slot and for each attribute identified by the identifying unit 15, a row indicating the counting result of the number of persons for which the predetermined reaction is not detected is also specified. However, the row may be omitted.

Then, the counting unit 125 updates the statistical information stored in the second memory unit 123 with the post-reflection statistical information, and outputs the statistical information to the output unit 121.

The output unit 121 outputs the statistical information that is generated by the counting unit 125. Herein, the output method can be identical to that explained in the first embodiment.

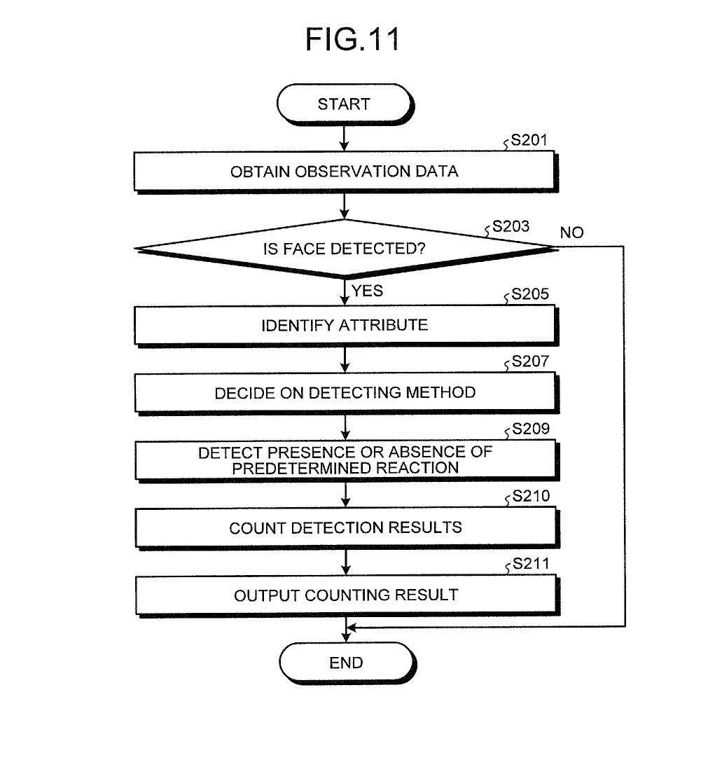

FIG. 11 is a flowchart for explaining an exemplary flow of operations performed according to the second embodiment.

Firstly, the operations performed at Steps S201 to S209 are identical to the operations performed at Steps S101 to S109 in the flowchart illustrated in FIG. 5.

Then, at Step S210, the counting unit 125 obtains the statistical information till the previous time from the second memory unit 123 and counts the detection results by reflecting, in the obtained statistical information, the detection result of the presence or absence of the predetermined reaction of a person as newly obtained by the detecting unit 19 (Step S210).

Subsequently, the output unit 121 outputs the latest statistical information that is generated by the counting unit 125 (Step S211).

In this way, in the second embodiment too, it is possible to achieve an effect identical to the effect achieved in the first embodiment. Particularly, according to the second embodiment, in an identical manner to the first embodiment, the presence or absence of the predetermined reaction can be correctly detected regardless of the person. Hence, the statistics of the presence or absence of the predetermined reaction of a plurality of persons can be counted with accuracy.

### Application Examples

Given below is the explanation of specific application examples of the detecting device 10 according the first embodiment and the detecting device 110 according to the second embodiment. Although the following explanation is given about application examples of the detecting device 110 according to the second embodiment, the application examples are applicable in an identical manner also to the detecting device 10 according to the first embodiment.

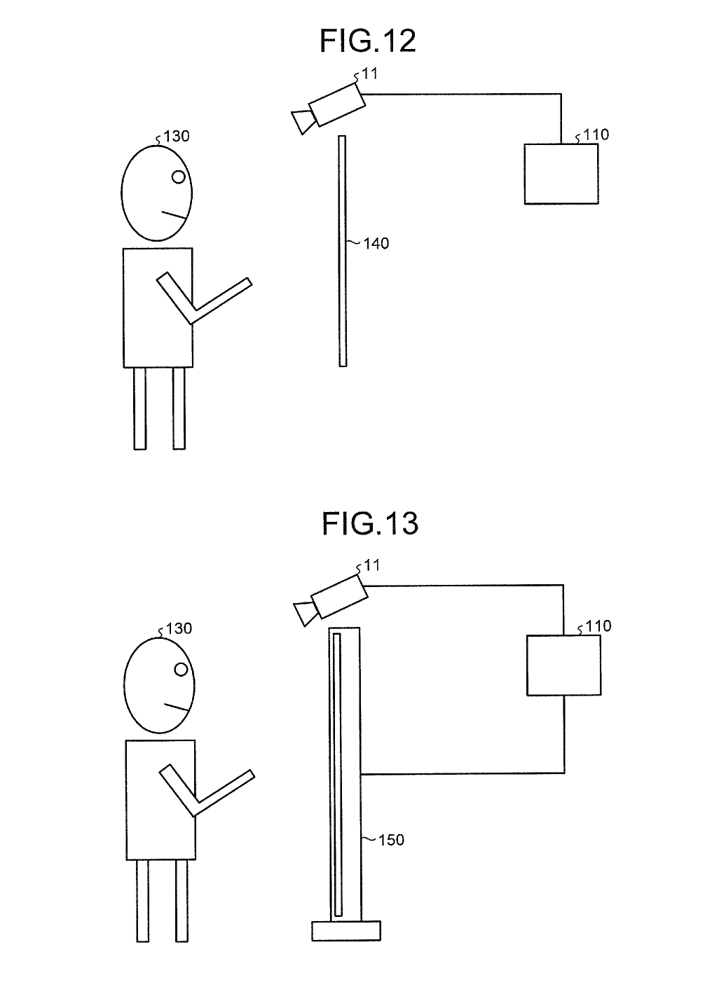

The detecting device 110 according to the second embodiment can be applied in, for example, a system for counting the presence or absence of the predetermined reaction of a person 130 who sees the contents of a poster 140 as illustrated in FIG. 12. Herein, the poster 140 can be a still image displayed on a display. In the example illustrated in FIG. 12, the input unit 11 is externally attached to the detecting device 110.

Alternatively, for example, the detecting device 110 according to the second embodiment can be applied in a system for counting the presence or absence of the predetermined reaction of the person 130 who watches the contents of a moving image displayed on a display 150 as illustrated in FIG. 13. In the example illustrated in FIG. 13 too, the input unit 11 is externally attached to the detecting device 110.

As illustrated in FIG. 13, in the case of detecting and counting the presence or absence of the predetermined reaction of a person who watches the contents of a moving image, it is desirable that the frame number of the moving image and the time elapsed since the first frame is played is output from a playing control unit (not illustrated), which controls the playing of moving images, to the detecting unit 19.

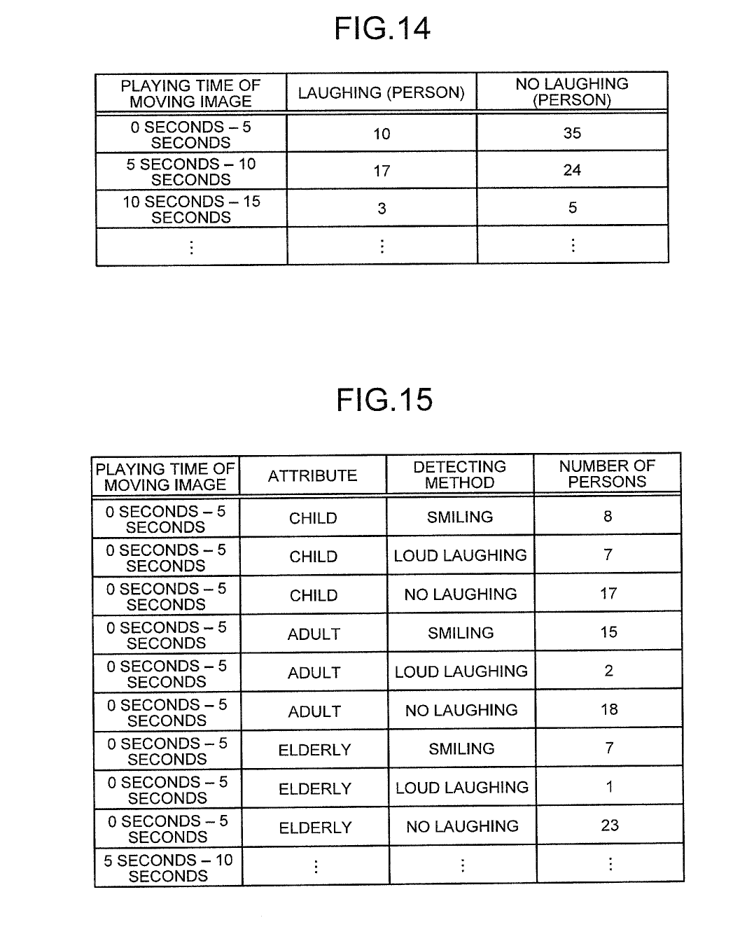

FIG. 14 is a diagram illustrating an example of statistical information that contains, for each period of elapsed time since the moving image is played, the count of the presence and the absence of detection of the predetermined reaction of “laughing” of persons.

FIG. 15 is a diagram illustrating another example of statistical information that contains, for each period of elapsed time since the moving image is played, for each attribute identified by the identifying unit 15, and for each detecting method associated with the attribute, the count of the presence and the absence of detection of the predetermined reaction of “laughing” of persons.

In the example illustrated in FIG. 15, “child”, “adult”, and “elderly” serve as the attributes. Regarding this, the identifying unit 15 can identify “younger than 20 years of age” as the attribute “child”; can identify “20 years of age and older but 60 years of age and younger” as the attribute “adult”; and can identify “60 years of age and older” as the attribute “elderly”.

In the example illustrated in FIG. 15, for each attribute, the detecting method (detector) for loud laughing and the detecting method (detector) for smiling are associated as the detecting methods. As the counting method for each detecting method, if smiling is detected in the detecting method for smiling and if loud laughing is not detected in the detecting method for loud laughing, then laughing can be counted as smiling. Moreover, if smiling is not detected in the detecting method for smiling and if loud laughing is detected in the detecting method for loud laughing, then laughing can be counted as loud laughing. Furthermore, if smiling is not detected in the detecting method for smiling and if loud laughing is not detected in the detecting method for loud laughing, it can be counted as not laughing. Moreover, if smiling is detected in the detecting method for smiling and if loud laughing is detected in the detecting method for loud laughing, then laughing can be counted in the category having the higher detection value (the higher value of detection result).

### Hardware Configuration

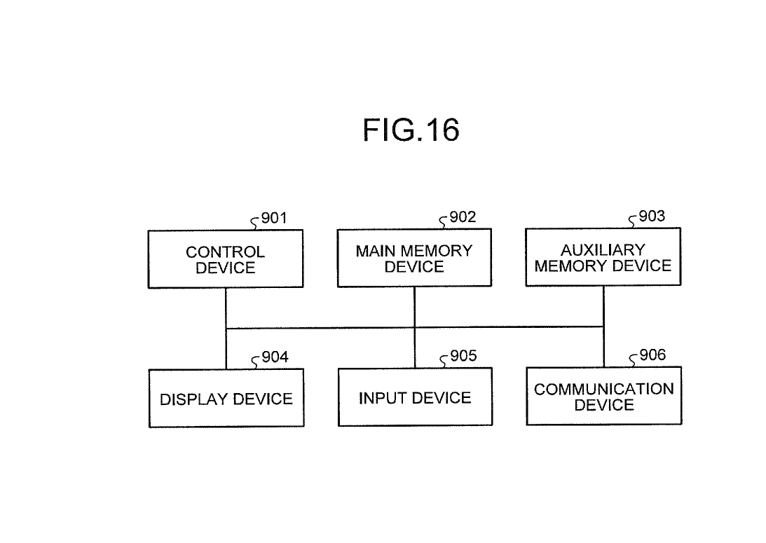

FIG. 16 is a diagram illustrating an exemplary hardware configuration of the detecting device according to the embodiments described above. As illustrated in FIG. 16, the detecting device according to the embodiments described above has a hardware configuration of a general-purpose computer that includes a control device 901 such as a CPU, a main memory device 902 such as a ROM or a RAM, an auxiliary memory device 903 such as an HDD or an SSD, a display device 904 such as a display, an input device 905 such as a video camera or a microphone, and a communication device 906 such as a communication interface.

The computer programs executed in the detecting device according to the embodiments described above are stored as installable or executable files in a computer-readable memory medium such as a compact disk read only memory (CD-ROM), a compact disk recordable (CD-R), a memory card, a digital versatile disk (DVD), or a flexible disk (FD).

Alternatively, the computer programs executed in the detecting device according to the embodiments described above can be stored in a computer connected to a network such as the Internet and can be downloaded from the network. Still alternatively, the computer programs executed in the detecting device according to the embodiments can be provided or distributed via a network such as the Internet. Still alternatively, the computer programs executed in the detecting device according to the embodiments can be stored in advance in a ROM.

The computer programs executed in the detecting device according to the embodiments contain modules for implementing the abovementioned constituent elements in the computer. As the actual hardware, the CPU reads the computer programs from the ROM or the HDD into the RAM and executes them, so that the abovementioned constituent elements are implemented in the computer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirits of the inventions.

For example, unless contrary to the nature thereof, the steps of the flowcharts according to the embodiments described above can have a different execution sequence, can be executed in plurality at the same time, or can be executed in a different sequence every time.

According to the embodiments described above, it becomes possible to enhance the detection accuracy of the predetermined reaction of persons.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A detecting device comprising:
processing circuitry configured to:
obtain observation data formed as a result of observing a person;
identify an attribute of the person based at least in part on the observation data; and
detect, based at least in part on the observation data, presence or absence of a predetermined reaction of the person by implementing a detecting method corresponding to the attribute.

2. The device according to claim 1, wherein the attribute includes at least any one of gender, age, generation, race, and name.

3. The device according to claim 1, wherein
in detecting, the processing circuitry is configured to obtain, from a memory unit storing therein attributes and one or more detecting methods appropriate for each attribute in association with each other, one or more detecting methods corresponding to the attribute of the person and detects the predetermined reaction by implementing the obtained one or more detecting methods.

4. The device according to claim 1, wherein the detecting method detects at least any one of a change in expression suggesting the predetermined reaction, a movement of face, and a movement of hands.

5. The device according to claim 1, wherein the processing circuitry is configured to output detection result.

6. The device according to claim 1, wherein
the processing circuitry is configured to:
count detection results of presence or absence of the predetermined reaction of a plurality of persons to generate statistical information; and
output the statistical information.

7. The device according to claim 6, wherein the statistical information is information obtained by counting, for each of the attribute or for each time slot, presence and absence of detection of the predetermined reaction.

8. The device according to claim 6, wherein the statistical information is information obtained by counting, for each of the attribute and for each detecting method corresponding to the attribute, a number of persons for which the predetermined reaction is detected.

9. The device according to claim 6, wherein the statistical information is information obtained by counting, for each time slot, for each of the attribute, and for each detecting method corresponding to the attribute, a number of persons for which the predetermined reaction is detected.

10. The device according to claim 1, wherein the observation data contains a taken image in which the person is captured.

11. The device according to claim 10, wherein the observation data further contains at least any one of sounds produced by the person and personal information of the person.

12. A detecting method comprising:
obtaining observation data formed as a result of observing a person;
identifying an attribute of the person based on the observation data; and
detecting, from the observation data, presence or absence of a predetermined reaction of the person by implementing a detecting method corresponding to the attribute.

13. A detecting device comprising:
a processor; and
a memory that stores processor-executable instructions that, when executed by the processor, cause the processor to:
obtain observation data formed as a result of observing a person;
identify an attribute of the person based at least in part on the observation data; and
detect, based at least in part on the observation data, presence or absence of a predetermined reaction of the person by implementing a detecting method corresponding to the attribute.
